(19) United States
(12) Patent Application Publication
(10) Pub. No.: US 2016/0146140 A1
(43) Pub. Date: May 26, 2016

(54) OPERATION OF A QUANTITY-CONTROLLED INTERNAL COMBUSTION ENGINE HAVING CYLINDER DEACTIVATION

(71) Applicant: MTU FRIEDRICHSHAFEN GMBH, Friedrichshafen (DE)

(72) Inventors: Wolfgang FIMML, Friedrichshafen (DE); Philippe GORSE, Friedrichshafen (DE); Manuel BOOG, Baindt (DE); Christian KUNKEL, Friedrichshafen (DE); Jörg MATTHIES, Salem (DE); Alexander BERNHARD, Meckenbeuren (DE); Tobias FRANK, Friedrichshafen (DE); Ludwig KLÄSER-JENEWEIN, Frickingen (DE); Andreas FLOHR, Manzell (DE)

(21) Appl. No.: 14/904,553

(22) PCT Filed: Apr. 25, 2014
(86) PCT No.: PCT/EP2014/001116

§ 371 Date: Jan. 12, 2016

(30) Foreign Application Priority Data
Jul. 12, 2013 (DE) 10 2013 213 697.8

(51) Int. Cl. F02D 41/00; F02B 37/18; F02D 13/02; F02B 37/16

(52) U.S. Cl. CPC F02D 41/0087; F02B 37/16; F02B 37/18; F02D 13/0226; F02D 41/0007; F02D 2041/0012

(57) ABSTRACT

A method for operating a quantity-controlled internal combustion engine having at least two cylinders, including the following steps: ascertaining a present operating state; determining a number of cylinders or cylinder groups to be deactivated in dependence on the present operating state; deactivating or keeping deactivated a fuel supply for at least one cylinder to be deactivated or at least one cylinder group if at least one cylinder or at least one cylinder group is to be deactivated; and opening a flow-influencing element associated with the at least one cylinder or the at least one cylinder group for a fresh mass supply to the at least one cylinder to be deactivated or the at least one cylinder group to be deactivated.

The invention pertains to a method for operating a quantity-controlled internal combustion engine according to claim 1 and to a quantity-controlled internal combustion engine according to claim 8.

In quantity-controlled internal combustion engines, also called “charge-controlled” engines, the quantity of combustible fresh air-fuel mixture supplied to the cylinders of the internal combustion engine is varied as a function of the operating or load point of the internal combustion engine to control its power output. The output of the internal combustion engine is thus controlled by varying the charges or quantities of combustible fresh air-fuel mixture supplied to the cylinders. An exact ratio between the supplied quantity of fuel and the supplied quantity of fresh air is always maintained at all operating points, wherein typically a stoichiometric ratio of fuel to fresh air is supplied to the cylinders, a lambda value of 1 thus being realized. It is possible, however, that the fuel-air ratio can vary with the operating point of the internal combustion engine; that is, it can also in particular deviate from a lambda value of 1 as a function of the operating point. Internal combustion engines are known in which the fuel-air mixture is produced in a gas mixer or carburetor and fed into an intake manifold leading to the individual cylinders. To control the quantities, flow-influencing elements such as throttle valves or intake valves with fully variable valve drives are used. It is possible for the fuel to be supplied to the cylinders by multi-point injection or by direct injection to each cylinder individually, whereas a quantity of fresh air adapted to the quantity of fuel is supplied separately through an intake manifold. Here, too, throttle valves or intake valves with fully variable valve drives can be used to control the amount of fresh air supplied. A cylinder-specific fuel supply makes it possible to idle individual cylinders or groups of cylinders under partial-load or no-load operating conditions. Quantity-controlled or charge-controlled internal combustion engines also include gas engines. For the operation of the internal combustion engine in the low-load range, small charges are required. Accordingly, the throttle valves or intake valves with fully variable valve drives are closed, so that only a small fresh mass flow is supplied to the cylinders. A small mass flow of exhaust gas is also produced. If the internal combustion engine comprises an exhaust gas turbocharger comprising a compressor driven by a turbine, only the small mass flow of exhaust gas acts on the turbine in the low-load range, so that the exhaust gas turbocharger, overall, rotates slowly and conveys only a small mass flow through the compressor. There is the danger that the pump limit of the compressor could be undershot, as a result of which the compressor pumping effect could develop. To prevent this, a fluid path is typically provided, which bridges the exhaust gas turbocharger and in which a valve element is arranged, which, when in a first functional position, can block the fluid path and, when in a second functional position, can open it. It is possible for the fluid path to bridge the turbine of the exhaust gas turbocharger and thus to be configured as a turbine bypass. By means of the valve element configured as a wastegate, the turbine bypass can then be opened in the low-load range in order to prevent the pump limit from being undershot. It is also possible for the fluid path to bridge the compressor of the exhaust gas turbocharger and thus to be configured as a compressor bypass. This compressor bypass is opened by the valve element in the low-load range, so that backflow along the fluid path from the high-pressure area downstream from the compressor into the low-pressure area upstream from the compressor is possible. In this way, the mass flow nominally conveyed by the compressor is increased, so that the pump limit is not undershot, and the compressor pumping effect does not occur. When the load is increased and the engine must produce more power, the valve element in the fluid path is closed, and the throttle valve or the intake valve with fully variable valve drive is opened to increase the charge supplied to the cylinders. The increased fresh mass being supplied to the cylinders also leads to an increase in the exhaust gas mass flow, i.e., to an increase in the exhaust gas energy available to the exhaust gas turbocharger. Thus, in turn, more charging pressure is available at the compressor. Overall, an iterative process develops, which ultimately leads to a steady equilibrium state. The problem, however, is that the exhaust gas turbocharger responds slowly and only after a certain delay, as a result of which the charging pressure builds up slowly and only after a delay, and thus the internal combustion engine responds sluggishly to an increase in load.

The invention is based on the goal of creating a method for operating a quantity-controlled internal combustion engine and to a quantity-controlled internal combustion engine in which the disadvantages mentioned above do not occur. In particular, it should be possible by means of the method to improve the behavior of the internal combustion engine when the load on it increases, wherein the engine should respond less slowly and with less delay, preferably spontaneously, to an increase in load.

The goal is achieved in that a method with the steps of claim 1 is created. Within the scope of the method, the instantaneous operating state of the internal combustion engine is ascertained first. As a function of the instantaneous operating state, the number of cylinders or groups of cylinder to be idled is determined. If the determined number is different from zero, i.e., if at least one cylinder or at least one cylinder group is to be idled or—depending on the preceding operating state—remain idled, the fuel feed to at least one cylinder to be idled or at least one cylinder group to be idled is deactivated or kept deactivated. A flow-influencing element assigned to the at least one cylinder or to the at least one cylinder group for the fresh mass feed to the at least one cylinder to be idled or to the at least one cylinder group to be idled is opened.

The method takes advantage of the fact that, in internal combustion engines with at least two cylinders to which the fuel is supplied individually by means of, for example, multi-point injection or by direct injection, it is possible to idle individual cylinders or cylinder groups by stopping the supply of fuel to them, as a result of which they do not fire. Normally, in the case of an internal combustion engine in which the individual cylinders or cylinder groups can be idled, appropriately assigned flow-influencing elements such as throttle valves or intake valves with continuously variable valve drives are closed, so that no fresh mass flow or only a minimal mass flow is supplied to the idled cylinders. Within the scope of the invention, however, it has been recognized that the idled cylinders can be used to pump fresh air through these cylinders without combustion. Cylinders are typically idled in the no-load state and/or in a partial-load operating state, wherein it is possible to idle a varying number of cylinders or cylinder groups as a function of the instantaneous operating state. In a full-load operating state, typically no cylinders are idled, i.e., all of the cylinders are firing. Within the scope of the method—in contrast to the otherwise conventional approach—a flow-influencing element assigned to the at least one idled cylinder or to the at least one idled cylinder group is opened, so that an increased fresh mass flow can pass through the least one idled cylinder. As a result, the overall charging mass conducted through the internal combustion engine is increased, as a result of which the exhaust gas mass flow is increased at the same time. This in turn leads to an increase in the energy available to the turbocharger. The pump limit of the compressor is effectively prevented from being undershot; the compressor pumping effect thus does not develop; and the additional energy can be used to build up the charging pressure. The rpm's of the turbocharger thus increase and the pressure level rises. This improves the dynamic response behavior of the turbocharger and also of the internal combustion engine, because the rotational speed of the turbocharger does not drop when in the low-load operating range, as it did in the past, wherein the turbocharger therefore does not have to be run up to speed before the engine can handle the increased load. Instead, the total compressor output is available immediately, i.e., as soon as the load increases.

Within the scope of the method, it is ascertained in particular whether or not the instantaneous operating state or operating point corresponds to no-load, to partial-load, or to full-load operation. In the no-load and partial-load states, cylinders are idled, wherein the specific number of cylinders or cylinder groups to be idled is determined preferably as a function of the instantaneous load requirement. In a simple embodiment of the method, it is always possible in the no-load or partial-load state to idle precisely one previously determined group of cylinders, such as one of the cylinder banks of a V-type engine. More complicated embodiments of the method make it possible to idle individual cylinders in completely variable fashion, wherein it is possible in particular, as a function of the operating point, not to idle any of the cylinders or to idle only a single cylinder. Especially under no-load conditions, it is possible for only one cylinder to be firing. In complex embodiments of the method, preferably all possibilities between these extremes can be realized, and any desired numbers of cylinders can be idled as a function of the operating point. The fuel feed and the flow-influencing element serve as a quantity control system for the internal combustion engine These are preferably coordinated with each other and/or actuated jointly in such a way that, at all times—preferably as a function of the operating point—a previously determined ratio of fuel to fresh air for charging the actively firing cylinders is obtained. The at least one flow-influencing element is preferably completely closed in a first functional position and completely opened in a second functional position. It is especially preferable for a large number, preferably a continuum, of functional positions representing variable degrees of opening to be realizable between these two functional positions. Within the scope of the method, the flow-influencing element assigned to the at least one cylinder to be idled or to the at least one group of cylinders to be idled is preferably opened completely, so that the maximum fresh mass flow can be conducted through the at least one idled cylinder.

A method is preferred which is characterized in that a valve element arranged in a fluid path bridging the exhaust gas turbocharger is closed. This is preferred when the method is carried out in an internal combustion engine comprising a compressor bypass, namely, a fluid path which bridges the fresh-mass compressor, wherein the valve element is arranged in the compressor bypass. Thanks to the method, it is no longer necessary in the lower load range to open the valve element in the fluid path, because the mass flow otherwise conducted according to the prior art along the fluid path is now conducted through the idled cylinder. Thus a sufficiently large mass flow is conducted through the compressor, so that the pump limit is not undershot and compressor pumping is reliably prevented. Conversely, an opening of the valve element in this case would have a negative effect on the output of the internal combustion engine.

Alternatively or in addition, it is preferable for a valve element arranged in a fluid path bridging the turbine of the exhaust gas turbocharger to be closed. In this case, it is no longer necessary within the scope of the method to open the valve element, configured as a wastegate, in the fluid path configured as a turbine bypass, for the purpose of relieving the load on the exhaust gas turbocharger.

It is therefore possible to use the method in an internal combustion engine comprising an exhaust gas turbocharger with a compressor bypass and a valve element arranged therein. It is also possible to use the method in an internal combustion engine comprising an exhaust gas turbocharger with a fluid path bridging the turbine, i.e., with a turbine bypass, and a valve element arranged therein, namely, a so-called wastegate. Finally it is possible to apply the method in an internal combustion engine comprising an exhaust gas turbocharger which comprises both a compressor bypass with a valve element and a turbine bypass with a valve element, namely, a so-called wastegate. In this case, it is preferable within the scope of the method for the valve elements in both fluid paths to be closed.

It is also possible, however, to operate an internal combustion engine according to the invention which does not have a fresh-mass compressor or a turbine-bridging fluid path. In this case, there will obviously be no valve element present which could be closed. The fluid path can be omitted, because, even in the lower load range and under no-load conditions, there is no fear of compressor pumping when the internal combustion engine is operated by the method proposed here.

A method is also preferred which is characterized in that no cylinder is idled when full-load operation is ascertained. This means that, in full-load operation, fuel is supplied to all of the cylinders of the internal combustion engine. Thus neither the problem of insufficient flow of exhaust gas nor the problem of compressor pumping occurs during full-load operation. Within the scope of the method, the number of cylinders or cylinder groups to be idled is determined to be zero when full-load operation is ascertained. Depending on the previous history of the operation of the internal combustion engine, especially as a function of the most recently ascertained operating state, the fuel supply is activated or maintained in the active state for all cylinders.

A method is also preferred in which fuel is supplied to the individual cylinders of the internal combustion engine by way of multi-point injection using injectors assigned to the individual cylinders. Multi-point injection does not mean that the fuel is injected directly into the cylinder in question; instead, the fuel is injected into sections of the intake manifold which branch off from a common intake manifold, these branches being assigned to the individual cylinders. The individual injectors are activated or deactivated as a function of the ascertained operating state in order to fire or to idle the assigned cylinders.

Alternatively, a method is preferred in which fuel is supplied to the individual cylinders of the internal combustion engine by way of direct injection using injectors assigned to the cylinders. In this case, the fuel is injected directly into the combustion chamber enclosed by the cylinder. In this embodiment of the method as well, the injectors are activated or deactivated to fire or to idle the cylinders as a function of the ascertained operating state.

A method is also preferred which is characterized in that fresh air is supplied to the cylinders by way of the fresh mass feed. This is the case in particular when the fuel is supplied by way of multi-point injection or direct injection. It is through the actuation of the injectors that the quantity of fuel supplied to the cylinders is controlled as a function of the operating point. By means of the flow-influencing elements, the supplied fresh-air mass is then adapted as appropriate to the quantity of fuel supplied, so that a previously determined ratio of fresh air to fuel is maintained. A stoichiometric ratio, i.e., a lambda value of 1, is preferably used. It is possible, however, for the ratio to vary as a function of the operating point.

Alternatively, a method is preferred in which a fuel-air mixture is supplied to the cylinders by way of the fresh mass feed. Especially in conjunction with multi-point injection and an embodiment in which an intake valve with fully variable valve drive is used as the flow-influencing element provided downstream from an injection site of the multi-point injection, it is possible accordingly for a fuel-air mixture to be supplied to the cylinders via the fresh mass feed, wherein the quantity of fuel-air mixture being supplied is controlled by the intake valve with fully variable valve drive.

A method is also preferred which is characterized in that a throttle valve is used as the flow-influencing element. It is possible for a throttle valve to be assigned to each individual cylinder or to each individual group of cylinders. According to one embodiment in particular, the method can be used to operate an internal combustion engine configured as a V-engine, wherein two throttle valves are used, one of which is assigned to each cylinder bank of the V-engine.

Alternatively, an embodiment of the method is preferred in which an intake valve with fully variable valve drive is used as the flow-influencing element. The intake valve with fully variable valve drive is arranged directly on the cylinder of the internal combustion engine and is thus to this extent assigned to it. Within the scope of the preferred embodiment described here, each cylinder preferably has its own intake valve with fully variable valve drive assigned to it, so that the fresh mass feed can be controlled individually for each cylinder.

An embodiment of the method is also possible in which both at least one throttle valve and at least one intake valve with fully variable valve drive are used as flow-influencing elements.

A method is also preferred which is characterized in that the cylinders are idled individually. In this case, a flow-influencing element, in particular an intake valve with fully variable valve drive, is preferably assigned to each cylinder. It is also possible for each cylinder to have its own assigned throttle valve, which is then arranged in a separate section of the intake manifold, namely, a section which leads from the common intake manifold to the cylinder.

Alternatively, an embodiment of the method is preferred in which the cylinders are idled in groups. A flow-influencing element is preferably assigned to each group of cylinders. This flow-influencing element is preferably configured as a throttle valve. A separate intake manifold, in which the associated flow-influencing element, especially the throttle valve, is arranged, is preferably assigned to each group of cylinders. It is possible in particular for the method to be implemented in a V-engine, wherein each cylinder bank of the V-engine has its own separate assigned intake manifold with a separate throttle valve.

The goal is also achieved in that a quantity-controlled internal combustion engine with the features of claim 8 is created. This comprises at least two cylinders, wherein a separate fuel feed device is assigned to each cylinder. A separate flow-influencing element for supplying fresh mass is assigned to at least two groups of cylinders or to each cylinder. The internal combustion engine comprises an exhaust gas turbocharger with a turbine and a compressor driven by the turbine. The turbine is arranged in an exhaust gas line of the internal combustion engine, wherein the compressor is arranged in a fresh mass line of the internal combustion engine. The internal combustion engine is characterized by an engine control unit, which is configured and set up to implement a method according to one of the previously described embodiments. As a result, the advantages which have already been explained in conjunction with the method are realized.

It is possible for the method to be implemented permanently on an electronic basis in the hardware of the engine control unit. Alternatively, it is possible for a computer program to be loaded into the engine control unit, this program comprising instructions on the basis of which the method is carried out by the engine control unit when the computer program us running on the engine control unit.

The internal combustion engine is configured as a reciprocating piston engine and especially preferably as a gas engine.

In a preferred exemplary embodiment, the internal combustion engine serves to drive in particular heavy land vehicles such as mining vehicles or trains, wherein the internal combustion engine is used in locomotives or railcars, or to drive ocean-going vessels or ships. The use of the internal combustion engine to drive a vehicle serving defensive purposes such as a tank is also possible. According to another exemplary embodiment, the internal combustion engine is stationary; for example, it can be used in a stationary power-generating installation to generate emergency power, continuous-load power, or peak-load power, wherein the internal combustion engine in this case preferably drives a generator. A stationary application of the internal combustion engine to drive an auxiliary unit such as a fire-extinguishing pump on an offshore drilling platform is also possible. The internal combustion engine is preferably configured as a diesel engine, as a gasoline engine, as a gas engine for operation with natural gas, biogas, special gas, or some other suitable gas. Especially when the internal combustion engine is configured as a gas engine, it is adapted to use in a block-type thermal power station for stationary power generation.

In a preferred exemplary embodiment, the separate fuel feed device assigned to each cylinder is configured as a multi-point injector. In a different exemplary embodiment, the fuel feed device is configured as an injector for direct injection.

An exemplary embodiment of the internal combustion engine is preferred in which at least one flow-influencing element is configured as a throttle valve or as an intake valve with fully variable valve drive. All of the flow-influencing elements are preferably configured either as throttle valves or as intake valves with fully variable valve drive. An exemplary embodiment is also possible, however, in which both at least one flow-influencing element configured as a throttle valve and at least one flow-influencing element configured as an intake valve with fully variable valve drive are provided.

A preferred exemplary embodiment of the internal combustion engine comprises a fluid path which bridges the compressor in the fresh mass line. Thus a compressor bypass is provided, so that the flow can detour around the compressor. A valve element is preferably arranged in the fluid path; when in a first functional position this valve element can block the fluid path, and when in a second functional position it can open it. It is possible in this case for the compressor bypass to be opened or closed as needed, in particular as a function of the operating point.

Alternatively or in addition, the internal combustion engine preferably comprises a fluid path which bridges the turbine in the exhaust gas line. Thus a turbine bypass is provided, so that the flow can detour around the turbine. A valve element is preferably arranged in the fluid path; when in a first functional position, this valve element can block the path, and, when in a second functional position, it can open it. A valve element of this type is also called a “wastegate”. It is possible in this case for the turbine bypass to be opened or closed as needed, especially as a function of the operating point.

An exemplary embodiment of the internal combustion engine is also preferred which comprises only one fluid path, namely, a path which bridges the compressor, i.e., which therefore comprises only a compressor bypass, with a valve element. An exemplary embodiment is also preferred which comprises a fluid path bridging only the turbine, i.e., which comprises only a turbine bypass with a valve element, namely, a so-called wastegate. Finally, an exemplary embodiment of the internal combustion engine is also preferred which comprises a first fluid path, which bridges the compressor, i.e., a compressor bypass, wherein a first valve element is provided in this first fluid path. This exemplary embodiment of the internal combustion engine also comprises a second fluid path, which bridges the turbine in the exhaust gas line, so that it is configured as a turbine bypass, wherein, in the second fluid path, a second valve element, namely a so-called wastegate, is provided. In this case, it is possible for both the compressor bypass and the turbine bypass to be opened or closed—preferably independently of each other—as needed, especially as a function of the operating point.

Thus it can be seen overall that the internal combustion engine preferably comprises at least one fluid path which bridges the exhaust gas turbocharger in the fresh mass line and/or in the exhaust gas line, wherein preferably a valve element is arranged in the fluid path so that, when in a first functional position, it can block the fluid path, and, when in a second functional position, it can open the path.

The engine control unit preferably comprises an operating state detection element for detecting the instantaneous operating state. It also preferably comprises a number-determining element for ascertaining the number of cylinders or groups of cylinders to be idled as a function of the instantaneous operating state.

An internal combustion engine is also preferred which is characterized in that the engine control unit is functionally connected to the at least two flow-influencing elements, to the at least two fuel feed devices, and preferably to the at least one valve element—if provided, so that the engine control unit can influence these elements. The engine control unit is thus configured and set up to actuate, in particular to open or to close, the at least two flow-influencing elements as a function of the operating point by way of these functional connections. The engine control unit is also preferably configured and set up to activate or to deactivate the at least two fuel feed devices as a function of the operating point by way of the functional connections. The engine control unit is also preferably configured and set up to open or to close, by way of the appropriate functional connections, the at least one valve element in the compressor bypass and/or in the turbine bypass as a function of the operating point.

Finally, an internal combustion engine is preferred which is characterized in that the engine control unit is functionally connected to a detection means for detecting the required load or torque, so that the load or operating state of the internal combustion engine can be ascertained. The engine control unit is preferably also functionally connected to a speed detection means, so that the rpm's of the internal combustion engine can also enter into the ascertainment of the load or operating state. Within the scope of the method, therefore, the instantaneous operating state is preferably ascertained as a function of an instantaneous load or torque demand and the instantaneous rotational speed of the internal combustion engine.

The description of the method on the one hand and of the internal combustion engine on the other are to be understood as complementary to each other. In particular, features which have been described explicitly or implicitly in conjunction with the method, preferably individually or in combination with each other, are features of an exemplary embodiment of the internal combustion engine. Similarly, method steps which have been described explicitly or implicitly in conjunction with the internal combustion engine, preferably individually or in combination with each other, are steps of an embodiment of the method.

The invention is explained in greater detail below on the basis of the drawings:

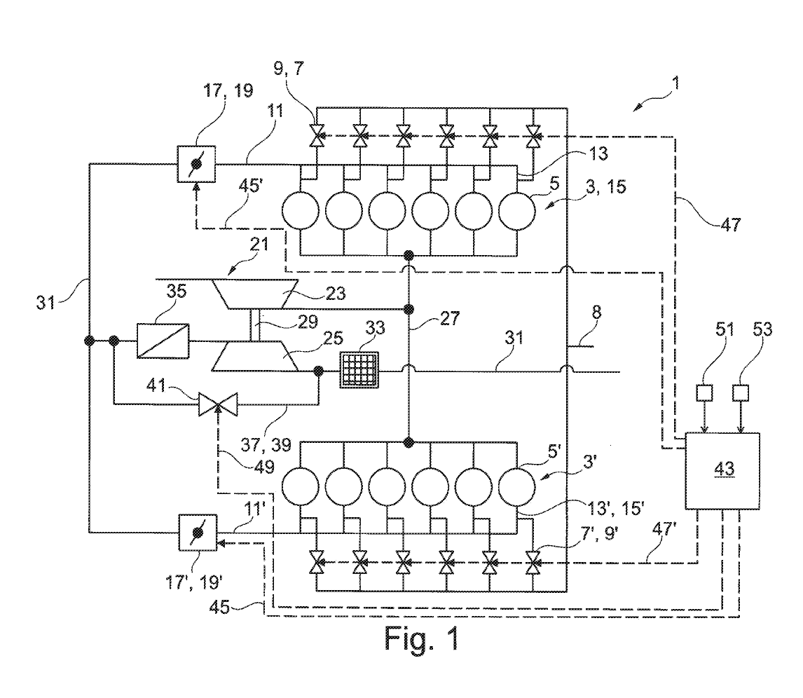

FIG. 1 shows a schematic diagram of an exemplary embodiment of an internal combustion engine; and

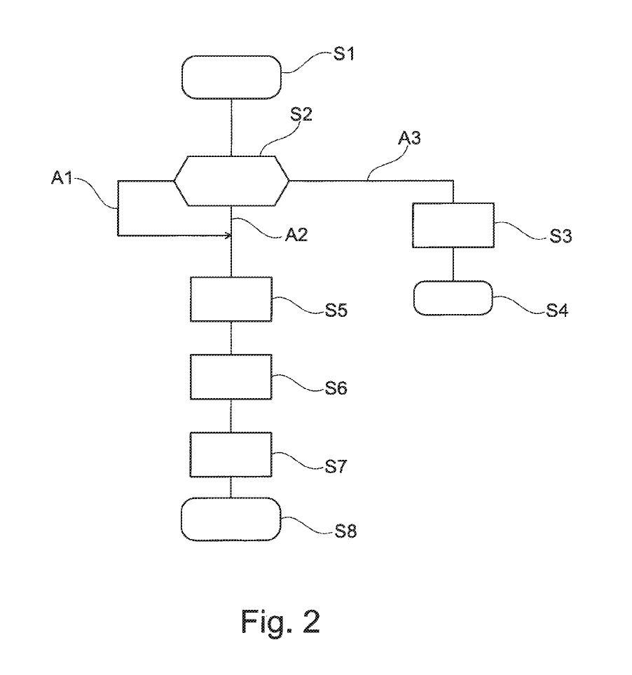

FIG. 2 shows a schematic diagram in the form of a flow chart of an embodiment of the method.

FIG. 1 shows a schematic diagram of a quantity-controlled internal combustion engine 1. It is configured here as a gas engine. The exemplary embodiment shown is configured as a reciprocating piston engine, here in the form of a V-engine, with two separate cylinder banks 3, 3′, wherein each cylinder bank 3, 3′ has six cylinders, only one of which, for the sake of clarity, is designated on each side by a reference numbers 5, 5′. The internal combustion engine thus comprises a total of twelve cylinders 5, 5′. A separate fuel feed device is assigned to each cylinder 5, 5′, wherein, for the sake of clarity, only one of the fuel feed devices for each cylinder bank 3, 3′ is designated by a reference number 7, 7′. Fuel, especially gas, is supplied to the fuel feed devices 7 through a common fuel line 8.

The fuel feed devices 7, 7′ assigned to the cylinders are configured here as injectors 9, 9′ for multi-point injection, wherein the fuel supplied to an individual cylinder 5, 5′ is sprayed into a section of the intake manifold which branches off from the common intake manifold 11, 11′ and which is assigned separately to each cylinder 5, 5′, wherein here a separate common intake manifold 11, 11′ is assigned to each cylinder bank 3, 3′, and wherein, for the sake of clarity, only one of the separate intake manifold sections is designated by a reference number 13, 13′ in each cylinder bank 3, 3′. It is obvious that the individual intake manifold sections 13, 13′ are fluidically connected at one end to the common intake manifolds 11, 11′ and at the other end to their assigned cylinders 5, 5′, so that fresh air—if the fuel feed is deactivated—or a fresh air-fuel mixture—if multi-point injection is active—can be supplied to each cylinder 5, 5′ by way of the separate intake manifold section 13, 13′ assigned individually to it.

In the exemplary embodiment shown here, the cylinder banks 3, 3′ form two groups 15, 15′ of cylinders 5, 5′, wherein a separate flow-influencing element 17, 17′ is assigned to each cylinder group 15, 15′. The flow-influencing elements 17, 17′ serve to influence the fresh mass feed, in particular the fresh mass flow rate, to the cylinders 5, 5′ or to the groups 15, 15′ of cylinders 5, 5′. In the exemplary embodiment shown here, the flow-influencing elements 17, 17′ are configured as throttle valves 19, 19′. The output of the internal combustion engine 1 controlled, first, by adaptation of the quantity of fuel supplied to the cylinders 5, 5′ by the fuel feed devices 7, 7′ and, second, by adaptation of the functional position of the flow-influencing elements 17, 17′ or throttle valves 19, 19′. The flow-influencing elements 17, 17′ are in particular actuated in such a way that the fresh air quantity supplied by way of the intake manifolds 11, 11′ and the intake manifold sections 13, 13′ is in a previously determined ratio—preferably as a function of the operating point—to the quantity of fuel supplied. Overall, therefore, a quantity control or charge control of the internal combustion engine 1 is realized.

The flow-influencing elements 17, 17′ are preferably adjustable continuously between a first, closed, functional position and a second, completely open, functional position.

The internal combustion engine 1 comprises an exhaust gas turbocharger 21 with a turbine 23 and a compressor 25 driven by the turbine. The exhaust gas formed during the combustion in the cylinders 5, 5′ is collected in an exhaust gas line 27 and sent to the turbine 23, which is arranged in the exhaust gas line 27. The turbine 23 is therefore driven by the exhaust gas mass flow of the internal combustion engine 1. It is functionally connected by a shaft 29 to the compressor 25, so that the compressor can be driven by the turbine 23.

The compressor 25 is arranged in a fresh mass line 31, by way of which, in the exemplary embodiment shown here, the internal combustion engine 1 can be supplied with fresh air. Upstream from the compressor 25, a fresh-air filter 33 is arranged. The fresh air compressed by the compressor 25 is cooled in the charging-air cooler 35 before it flows onward through the fresh mass line 31 to the flow-influencing elements 17, 17′ and through them into the intake manifolds 11, 11′.

In the exemplary embodiment shown here, a fluid path 37 is provided, which bridges the compressor 25 in the fresh mass flow 31 line, as a result of which a compressor bypass 39 is realized. In the fluid path 37, a valve element 41 is arranged, which, when in a first functional position, can block the fluid path 37 and, when in a second functional position, can open the path. The valve element 41 is preferably variable, even more preferably continuously variable, between these two extreme positions, so that the open cross section through the fluid path 37 can be varied—especially as a function of the operating point.

In another exemplary embodiment, it is possible to provide a fluid path which bridges the turbine 23 in the exhaust gas line 27, as a result of which a turbine bypass is then realized. In this bypass, a valve element, namely, a so-called wastegate, is preferably arranged, which, when in a first functional position, can block the bypass and, when in a second functional position, can open it. The valve element configured as a wastegate is preferably variable, even more preferably continuously variable, between these two extreme positions, so that the open cross section through the turbine bypass can be varied—in particular as a function of the operating point.

The internal combustion engine 1 comprises an engine control unit 43, which preferably regulates the operation of the engine in an open-loop or preferably in a closed-loop fashion. In particular, the engine control unit 43 is set up to implement the method described here.

The engine control unit 43 is for this purpose functionally connected to the flow-influencing elements 17, 17′, as indicated schematically by the dashed lines 45, 45′. The engine control unit 43 is also functionally connected to the fuel feed devices 7, 7′, as indicated schematically by the dashed lines 47, 47′. Finally, the engine control unit 43 is also functionally connected to the valve element 41, as indicated schematically by the dashed line 49. By means of these functional connections, the functional positions of the individual elements can be adjusted by the engine control unit 43; in particular, the engine control unit 43 can open and close the flow-influencing elements 17, 17′ and the valve element 41, and it can activate and deactivate the fuel feed devices 7, 7′ and thus control, in open-loop or closed-loop fashion, the quantity of fuel supplied by the fuel feed devices 7, 7′.

In the exemplary embodiment shown here, it is possible to idle one of the cylinder banks 3, 3′ in the low-load range and/or in the no-load state by deactivating the fuel feed devices 7, 7′ assigned to the cylinder bank 3, 3′ to be idled. Accordingly, the cylinders, 5, 5′ of the idled cylinder bank 3, 3′ are no longer firing and no longer contribute to the output of the internal combustion engine 1. The output is provided instead only by the cylinder bank 3, 3′ which is still firing, i.e., by the cylinders 5, 5′ of that bank.

According to the known methods for operating the known internal combustion engines, the flow-influencing element 17, 17′ assigned to the idled cylinder bank 3, 3′ is closed in this reduced-output operating state, so that no fresh air or only a small quantity of fresh air flows through the idled cylinder bank 3, 3′. At the same time, the valve element 41 is opened —as previously described—to prevent the pump limit of the compressor 25 from being undershot and thus to prevent the compressor pumping effect from occurring. This approach suffers from the disadvantage, however, that the exhaust gas turbocharger 21 and thus also the entire internal combustion engine 1 respond very slowly to an increase in load and deliver the required power only after a certain delay.

Therefore, according to the method proposed here, the following procedure is adopted: The engine control unit 43 ascertains the operating state which is present at the moment in question; in particular, it determines whether the instantaneous operating state corresponds to no-load, to partial-load, or to full-load operation. For this purpose, the engine control unit 43 is preferably functionally connected to a detection means 51 for detecting the load or torque demand and preferably also to a speed detection means 53. From the instantaneous load or torque demand and preferably also the instantaneous speed, the instantaneous operating state is ascertained by the engine control unit 43. If a partial-load state or a no-load state is found, one of the cylinder banks 3, 3′ is idled, in that the fuel feed devices 7, 7′ for this cylinder bank 3, 3′ are deactivated.

Without implying any limitation on the generality of the description, it is assumed in the following, that, in the exemplary embodiment shown here, the first cylinder bank 3 is idled in both the low-load range and in the no-load state and that the second cylinder bank 3′ is firing under these conditions. The engine control unit thus deactivates the fuel feed devices 7, so that the cylinders 5 are no longer firing. At the same time—in contrast to the known approach—the flow-influencing element 17, i.e., the throttle valve 19, is completely opened, however, so that the maximum possible amount of fresh air flows to the cylinders 5. This fresh-air flow is pumped through the cylinders 5 without combustion and thus contributes to the mass flow of exhaust gas conveyed through the exhaust gas line 27.

Accordingly, the turbine 23 receives not only the exhaust gas from the firing cylinders 5′ but also the fresh air mass from the cylinders 5, so that, overall, a large mass flow is conducted through the turbine 23. The turbine 23 and the compressor 25 are thus turning at high speed even in the partial-load and no-load states. There is no fear that the pump limit of the compressor 25 can be undershot, which also means that there is no risk of the compressor pumping effect. The engine control unit 43 thus closes the valve element 41, because it is no longer necessary to return fresh air through the fluid path 37, wherein this would in fact have a negative effect on the output of the internal combustion engine 1.

In another exemplary embodiment, the engine control unit, alternatively or in addition, preferably closes a valve element, namely, a so-called wastegate, arranged in a turbine bypass.

When the load increases, there is no longer any need for the exhaust gas turbocharger 21 to run up to speed, since it is already operating at full speed and full output. Therefore, both it and the internal combustion engine 1 respond immediately, without any delay, to an increase in load, and in particular the required torque is made available immediately. The dynamic response behavior of the internal combustion engine 1 is thus improved.

In the full-load operating state, the engine control unit 43 activates the fuel feed devices 7, 7′ of both cylinder banks 3, 3′, so that all of the cylinders 5, 5′ are firing.

At steady-state operating points, i.e., in operating states which do not change, the engine control unit 43 makes no change to the activation or deactivation state of the fuel feed devices 7, 7′. These are therefore activated or deactivated in correspondence with the current, steady-state operating situation.

As an alternative to the exemplary embodiment shown in FIG. 1, an exemplary embodiment of the internal combustion engine 1 is possible in which, instead of the throttle valves 19, 19′, an intake valve with fully variable valve drive is assigned to each of the cylinders 5, 5′. In this type of exemplary embodiment, the engine control unit 43 preferably determines the number of cylinders to be idled as a function of the instantaneous operating state, wherein, depending on the required output, any desired number of cylinders 5, 5′ can be idled as long as at least one cylinder 5, 5′ remains active. In full-load operation, preferably all cylinders 5, 5′ are firing. In the idling state, preferably only one of the cylinders 5, 5′ is firing. In all of the output ranges in between, the number of firing cylinders varies from one cylinder 5, 5′ to all cylinders 5, 5′. It is not absolutely necessary for all of the idled cylinders 5, 5′ to belong to the same cylinder bank 3, 3′. On the contrary, it is possible to distribute the idled cylinders 5, 5′ variably between the two cylinder banks 3, 3′, wherein it is especially preferable to take into account the need to balance the torque or force acting on the crankshaft.

To idle the cylinders 5, 5′ individually, the assigned fuel feed device 7, 7′ in question is deactivated. At the same time, the assigned flow-influencing element 17, 17′ for the idled cylinders 5, 5′, here the intake valve with fully variable valve drive, is completely opened to convey the maximum possible fresh air mass through the idled cylinders into the exhaust gas line 27.

As an alternative to the exemplary embodiment shown in FIG. 1, an exemplary embodiment of the internal combustion engine 1 is also possible in which, instead of multi-point injection, direct injection is provided, wherein the injectors 9, 9′ meter fuel directly into the cylinders 5, 5′.

In an exemplary embodiment of the internal combustion engine 1 which comprises multi-point injection on the one hand and intake valves with fully variable valve drive on the other, an air-fuel mixture is supplied to the cylinders 5, 5′ in the firing state by way of the fresh mass feed, wherein the supplied quantity of the fuel-air mixture is varied by way of the position of the intake valves with fully variable valve drive.

FIG. 2 shows a schematic diagram of an embodiment of the method in the form of a flow chart. The method begins with step Si. In step S2, the instantaneous operating state of the internal combustion engine 1 ascertained, wherein in particular it is determined whether the instantaneous operating state corresponds to no-load operation, partial-load operation, or full-load operation.

In a preferred embodiment of the method, the load or torque demand present at the moment in question is compared with a previously determined lower limit value and also with a previously determined upper limit value. If the load demand is less than or equal to the lower limit value, the no-load operating state is recognized. Alternatively, it is also possible for no-load operation to be recognized when the load demand is below the lower limit value, wherein, when the load demand is equal to the lower limit value, partial-load operation is recognized instead of the no-load state. If the no-load operating state is ascertained, the method continues along branch A1.

If the load demand is less than or equal to the previously determined upper limit and greater than or equal to the lower limit, partial-load operation is recognized. Alternatively, it is also possible for partial-load operation to be recognized when the load demand is lower than the upper limit, wherein partial-load operation is no longer recognized when the load demand is equal to the upper limit. If partial-load operation is ascertained, the method continues along branch A2.

Finally, full-load operation is recognized when the load demand is greater than the upper, previously determined limit. Alternatively, it is also possible for full-load operation to be recognized as soon as the load demand becomes equal to the upper, previously determined limit. If full-load operation is ascertained, the method continues along branch A3. In branch A3, there follows a third method step S3, in which all the cylinders 5, 5′ of the internal combustion engine 1 fire or are kept firing. The method ends in this case with step S4.

The method is preferably carried out continuously; that is, upon completion of step S4, it begins again with step Sl.

In the embodiment of the method shown in FIG. 2, branches A1 and A2 are brought together, wherein the method continues in both cases with step S5. In this step, a number of cylinders 5, 5′ to be idled is determined, preferably as a function of the ascertained operating state. If the method is being carried out with the exemplary embodiment of the internal combustion engine 1 according to FIG. 1, the first cylinder bank 3 is always deactivated first in step S5; that is, the fuel feed devices 7 are deactivated. Alternatively, it is possible for the fuel feed devices 7, 7′ of selected cylinders 5, 5′ to be deactivated, wherein the number of these cylinders depends on the ascertained operating state.

In step S6, the flow-influencing elements 17, 17′ assigned to the idled cylinders 5, 5′ determined in step S5 are completely opened. In the exemplary embodiment of the internal combustion engine 1 according to FIG. 1, the throttle valve 19, for example, is completely opened. Alternatively, it is possible for the intake valves with fully variable valve drive assigned to the idled cylinders 5, 5′ to be completely opened.

An exemplary embodiment is also possible in which more than two cylinder groups 15, 15′ are provided, wherein a flow-influencing element 17, 17′ is assigned to each cylinder group 15, 15′. In this case, a number of cylinder groups 15, 15′ to be idled is determined in step S5, wherein, in step S6, the flow-influencing elements 17, 17′ assigned to the cylinder groups 15, 15′ to be idled are completely opened.

The complete opening of the flow-influencing elements 17, 17′ is preferably not carried out abruptly; on the contrary, it is carried out by opening them continuously along a ramp or in a stepwise manner.

In step S7, the valve element 41 is closed. Additionally or alternatively, it is possible that a valve element in a turbine bypass, i.e., a so-called wastegate, could be closed. This, too, is preferably not done abruptly but rather in the form of a ramp, i.e., continuously, or in a stepwise manner.

The method ends with step S8.

It is possible for step S7 to be omitted, especially when no fluid path 37 or compressor bypass 39, no valve element 41, and no turbine bypass with a wastegate are provided in the exemplary embodiment of the internal combustion engine 1 in which the method is implemented.

The method is preferably carried out continuously during the operation of the internal combustion engine 1, so that, after step S8, it begins immediately again with step S1. If an unchanging operating state is ascertained in step S2, i.e., a state which does not differ from the operating state determined in the preceding run-through of the method, there will no change in steps S5-S7 or S3. The deactivated and/or activated fuel feed devices 7 are thus kept activated or kept deactivated, and the positions of the flow-influencing elements 17, 17′ and of the valve element 41 are not changed. The engine control unit 43 preferably comprises a memory area, in which the most recently ascertained operating state is stored. It is especially preferable for a history of successive operating states to be recorded. It is then possible to decide in step S2 whether or not steady-state operating conditions are present. If they are present, step S3 or steps S5-S7 can then be skipped, and there is no need for any recalculations.

Overall, it can be seen that, by means of the method and the internal combustion engine 1, it is possible to improve the behavior of the quantity-controlled internal combustion engine 1, especially a gas engine, and thus in particular to improve its dynamic response behavior when there is an increase in engine load.

1-10. (canceled)

11. A method for operating a quantity-controlled internal combustion engine with at least two cylinders, comprising the steps of:
ascertaining an instantaneous operating state;
determining a number of cylinders or cylinder groups to be idled as a function of the instantaneous operating state;
deactivating or keeping deactivated a fuel feed for at least one cylinder or at least one cylinder group to be idled, when at least one cylinder or at least one cylinder group is to be idled; and
opening a flow-influencing element assigned to the at least one cylinder or the at least one cylinder group for a fresh mass feed to the at least one cylinder to be idled or the at least one cylinder group to be idled.

12. The method according to claim 11, further comprising closing a valve element arranged in a fluid path bridging an exhaust gas turbocharger.

13. The method according to claim 11, wherein, when full-load operation is ascertained, no cylinder is idled or fuel is supplied to all cylinders.

14. The method according to claim 11, including supplying fuel to individual cylinders of the internal combustion engine via mufti-point injection or via direct injection by injectors assigned to the cylinders, wherein the injectors are activated or deactivated as a function of the operating state.

15. The method according to claim 11, including supplying fresh air or a fresh air-fuel mixture to the cylinders via the fresh mass feed.

16. The method according to claim 11, wherein the flow-influencing element is a throttle valve or an intake valve with fully variable valve drive.

17. The method according to claim 11, including idling the cylinders individually or in groups.

18. The method according to claim 17, wherein a flow-influencing element is assigned to each cylinder or to each group of cylinders.

19. The method according to claim 18, wherein the flow-influencing element is a throttle valve or an intake valve with fully variable valve drive.

20. A quantity-controlled internal combustion engine, comprising:
at least two cylinders;
a separate fuel feed device assigned to each cylinder;
a separate flow-influencing element for a respective fresh mass feed assigned to at least two groups of cylinders or to each cylinder;
an exhaust gas turbocharger with a turbine and a compressor driven by the turbine, wherein the turbine is arranged in an exhaust gas line, wherein the compressor is arranged in a fresh mass line;
at least one fluid path that bridges the exhaust gas turbocharger in the fresh mass line and/or in the exhaust gas line;
a valve element arranged in the fluid path, the valve element having a first functional position that blocks the fluid path and a second functional position that opens the fluid path; and
an engine control unit, configured and set up to implement a method according to claim 11.

21. The quantity-controlled internal combustion engine according to claim 20, wherein the engine control unit is functionally connected to the flow-influencing elements, to the fuel feed devices, and to the valve element for influencing them.

22. The quantity-controlled internal combustion engine according to claim 20, wherein the engine control unit is functionally connected to a detection device for load demand or torque demand, and to a speed detection device.

23. The quantity-controlled internal combustion engine according to claim 20, wherein the engine is a gas engine.
